(19) United States
(12) Patent Application Publication
(10) Pub. No.: US 2006/0004840 A1
(43) Pub. Date: Jan. 5, 2006

(54) Index adding program of relational database, index adding apparatus, and index adding method

(75) Inventor: Toshiaki Senda, Yokohama (JP)

Correspondence Address: Patrick G. Burns, Esq.;GREER, BURNS & CRAIN, LTD., Suite 2500, 300 South Wacker Dr., Chicago, IL, 60606, US

(73) Assignee: Fujitsu Limited

(21) Appl. No.: 10/996,762

(22) Filed: Nov. 24, 2004

(30) Foreign Application Priority Data
Jul. 2, 2004 (JP) 2004-196488

(51) Int. Cl. G06F 17/00

(52) U.S. Cl. 707/102

(57) ABSTRACT

An index adding program, index adding apparatus, and index adding method of a relational database, that enables dynamic and efficient addition of a new index without stopping service to an application, by contriving a method of reflecting an update log to the index. The index of the relational database is initially generated and an updating log for the relational database is accumulated during the initial index generation. Thereafter, data corresponding to an update request to the relational database is present in the index; the update request is reflected to the index. If the request is not present, update request is stored in the work area. Further, reflecting of an accumulated update log to the initially generated index is sequentially executed, the update log is disregarded, if the data corresponding to the update log is stored in the work area, or alternatively, the update log is reflected to the index, if data corresponding to the update log is not stored in the work area.

### BACKGROUND OF THE INVENTION

1. Field of the Invention

The present invention relates generally to a technique in a relational database (hereunder referred to as a “database”) to which access has been accelerated using an index, that enables dynamic and efficient addition of a new index without stopping a service to an application. More particularly, the present invention relates to an index adding program of relational database, index adding apparatus, and index adding method.

2. Description of the Related Art

As a general method of increasing the speed of access to a database by means of an SQL (Structured Query Language) statement, a technique that uses a BTREE (binary tree) type index is widely known. In designing a system that uses a database, design of an index corresponding to an SQL statement issuing from an application is performed. Then, before system operation begins, definition and generation of the index is actually performed on the database. On the other hand, after system operation begins, there are cases where addition of new indexes becomes necessary, accompanying the addition of SQL statements due to service expansion and so forth. Furthermore, since a system that uses a database is generally operated continuously 24 hours a day, it is required that a new index can be added to a table while the table is being renewed by the application.

As a method of adding an index to a table that is being updated, as disclosed in “Technical Comparison of Oracle9i Database and IBM DB2 UDB: Focus on High Availability”, a technique is implemented in which an update log of a table whose index is being generated, is accumulated and the update log of the table is reflected after the index has been generated.

However, even with this implementation technique, upon reflecting the update log of the table to the index, the service to the application must have been temporarily stopped, so that 24 hours continuous operation of the system has been extremely difficult. Moreover, there was also concern that if index generation requires a long time, the volume of the update log of the table also increases, and the amount of time that is required to reflect this update log to the index, that is, the service stop time, must have become longer. Furthermore, in order to avoid stopping the service to the application, it has been considered to additionally accumulate the update log of the table when reflecting the update log of the table to the index. However, there was a further concern that accumulation of the update log and its reflection might not be completed in time.

### SUMMARY OF THE INVENTION

Therefore, by addressing the abovementioned heretofore problems, an object of the present invention is to provide a general technique that enables dynamic and efficient addition of a new index without stopping service to the application, through contriving a method of reflecting the update log to the index.

Therefore, an index adding technique according to the present invention accumulates an update log for a relational database during initial index generation of the relational database. On the other hand, after the initial index generation, if data corresponding to an update request to the relational database is present in the index, the update request is reflected in the index, whereas if data corresponding to an update request is not present in the index, the update request is stored in a working area. Moreover, when sequentially reflecting the update log to the index, if data corresponding to the update log is stored in the working area, the update log is disregarded, whereas if data corresponding to the update log is not stored in the working area, the update log is reflected to the index.

According to this configuration, after the initial index generation, the update request to the relational database is directly reflected if data corresponding to the index is present, whereas it is stored in the working area if data corresponding to the index is not present. Moreover, regarding the update log accumulated during the initial index generation, if the corresponding data is stored in the working area, the order of update to the index is determined to be inverted, and since insertion or deletion is performed in this order, it is considered to have no effect, and the update log is thus disregarded. On the other hand, if the update log is not stored in the working area, it is determined that the update order for the index is guaranteed, and the update log is reflected to the index.

Therefore, when the update log is reflected to the index, the processing order for the index is guaranteed by referring to the working area, and thus a new index can be added dynamically and efficiently without stopping the service to the application.

### BRIEF DESCRIPTION OF THE DRAWINGS

The above and other objects, features and aspects of the present invention will become more apparent from the following description of preferred embodiments thereof, in conjunction with the appended drawings wherein:

FIG. 1 is an overall block diagram of an index adding apparatus according to the present invention;

FIG. 2 is a schematic explanatory diagram of initial index generation processing;

FIG. 3 is a schematic explanatory diagram of log reflection processing;

FIG. 4 is an explanatory diagram of a key record;

FIG. 5 is a flow chart showing a main routine that is executed in an index generation processing section;

FIG. 6 is a flow chart showing a subroutine of the initial index generation processing;

FIG. 7 is a flow chart showing a subroutine of the log reflection processing;

FIG. 8 is a flow chart of the content of the processing that is executed by an index generating daemon;

FIG. 9 is a flow chart of the content of the processing that is executed by the index generating daemon;

FIG. 10 is a flow chart of the content of the processing that is executed by an application;

FIG. 11 is a schematic explanatory diagram of first half processing of the initial index generation processing;

FIG. 12 is a schematic explanatory diagram of latter half processing of the initial index generation processing;

FIG. 13 is an explanatory diagram of the processing of a table update request during log reflection processing; and,

FIG. 14A is a detailed explanatory diagram in the log reflection processing in the case where data corresponding to the log is present; and,

FIG. 14B is a similar detailed explanatory diagram in the log reflection processing in the case where data corresponding to the log is not present.

### DESCRIPTION OF THE PREFERRED EMBODIMENT

Hereunder is a detailed description of the present invention, with reference to the appended drawings.

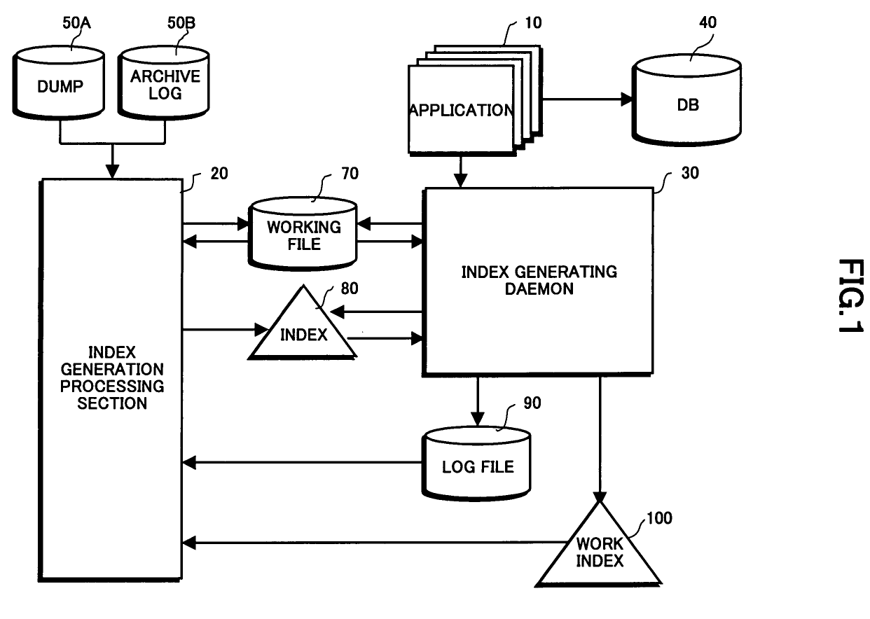

Referring to FIG. 1 showing an overall configuration of an index adding apparatus of a database (hereafter referred to as an “index adding apparatus”), in which the present invention is applied to a computer system provided with at least a central processing unit (CPU) and a memory, the index adding apparatus is configured including various kinds of functions, that is, an application 10, an index generation processing section 20, and an index generating daemon 30, which are realized by an index adding program loaded into the memory. As will be described later, in the index adding apparatus, a new index is added dynamically and efficiently without stopping service to the application 10, by sequentially executing two processes, namely; “initial index generation processing”, and “log reflection processing”.

The application 10 uses SQL statements to perform table-updates such as deletion, addition, or update, for a two-dimensional table that configures a database (DB) 40. At this time, as backup data provided against destruction of the DB 40 due to disk failure and so forth, a dump file 50A in which is saved table data at a certain point in time, and an archive log file 50B in which is recorded the update contents for the table, are appropriately acquired. Here, by configuring backup data from the dump file 50A and the archive log file 50B, the DB 40 can be reconstructed at an arbitrary point in time using as little memory capacity as possible.

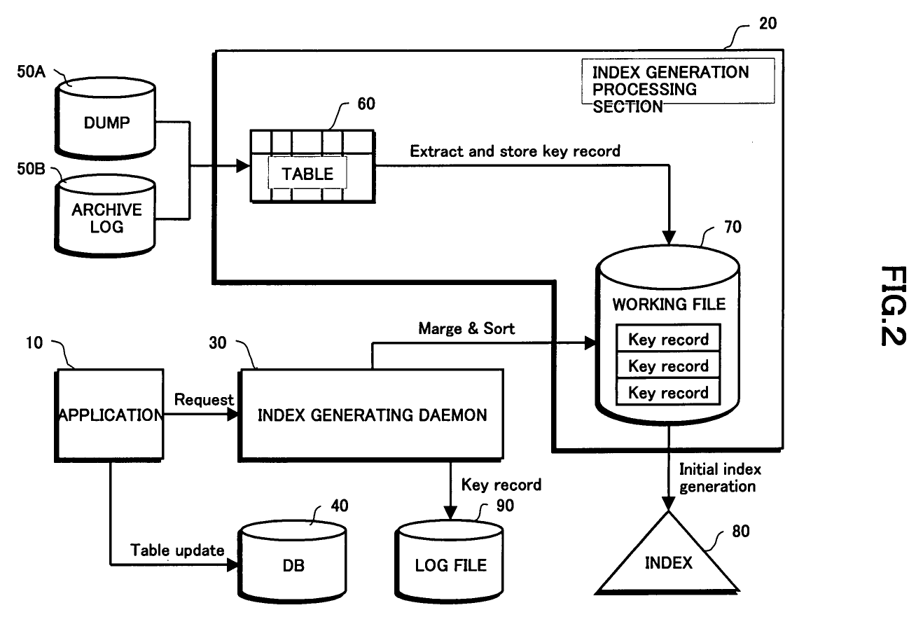

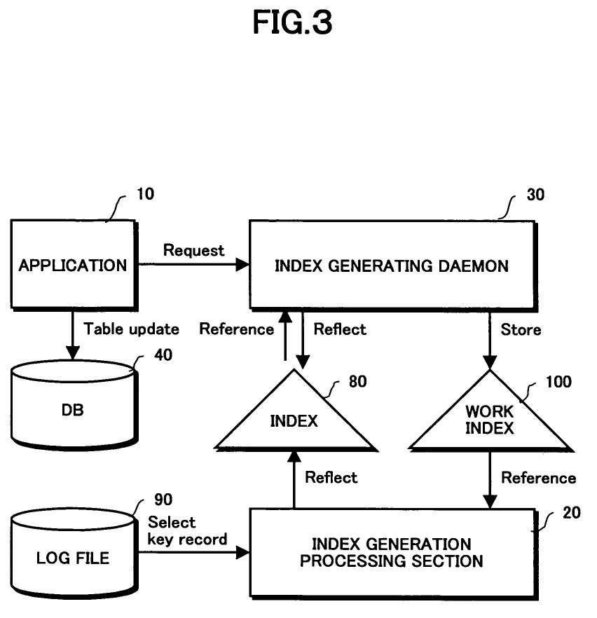

As shown in FIG. 2, in the initial index generation processing, the index generation processing section 20 reads the dump file 50A and the archive log file 50B and creates a table 60. Then it extracts key records from the table 60 and stores them on a working file 70 serving as a second work area, and initially generates from the key records stored in the working file 70, an index 80, which is to be newly added. Moreover, as shown in FIG. 3, in the log reflection processing, the index generation processing section 20 reflects to the index 80, a log file 90 in which is stored the table update content that occurs during the initial index generation processing.

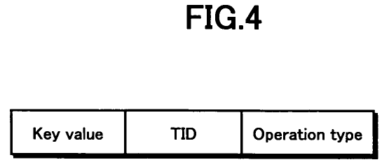

Here, as shown in FIG. 4, the key record is configured comprising; a “key value” that indicates a column data that configures the index, a “TID” that holds a unique value to identify the location where the target data is stored, and an “operation type” that indicates insertion or deletion of the index. The operation type of the key record created from the dump file 50A and the archive log file 50B is always “insertion”. Furthermore, update of the key record is expressed by “deletion” and “insertion”.

In the initial index generation processing, until the storing of key records to the working file 70 is completed, the index generating daemon 30, as shown in FIG. 2, sorts the key records in accordance with the key value, while merging the key records corresponding to the request from the application 10, with the working file 70. Moreover, after completing storing the key records in the initial index generation processing, the index generating daemon 30 stores the key records corresponding to the request from the application 10 in the log file 90. On the other hand, as shown in FIG. 3, in the log reflection processing, according to the request from the application 10, the index generating daemon 30 either directly reflects the update content of the table to the index 80, or stores the update content of the table in the first working area, or in a work index 100 serving as a working area.

Next, the operation of the index adding apparatus having such a configuration is described.

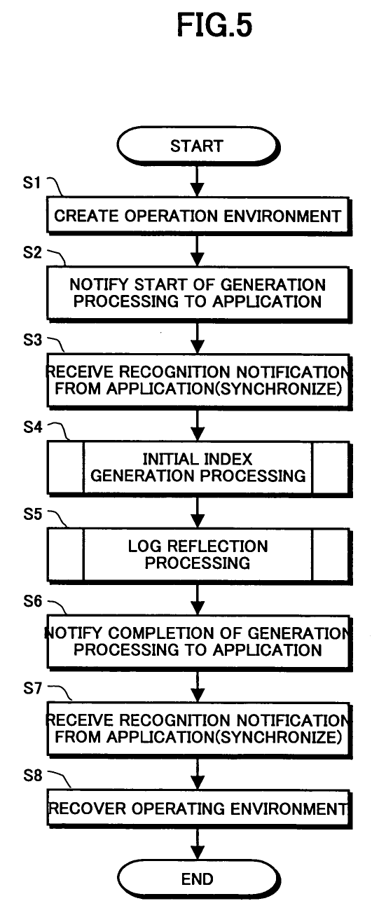

FIG. 5 shows the main routine of the processing content that is executed in the index generation processing section 20, in accordance with a user instruction or a predetermined schedule.

In step 1 (abbreviated to “S1” in diagram, and similarly hereunder), an operation environment is created.

In step 2, the start of the generation processing is notified to the application 10.

In step 3, recognition notification from the application 10 is received in order to synchronize with the application 10.

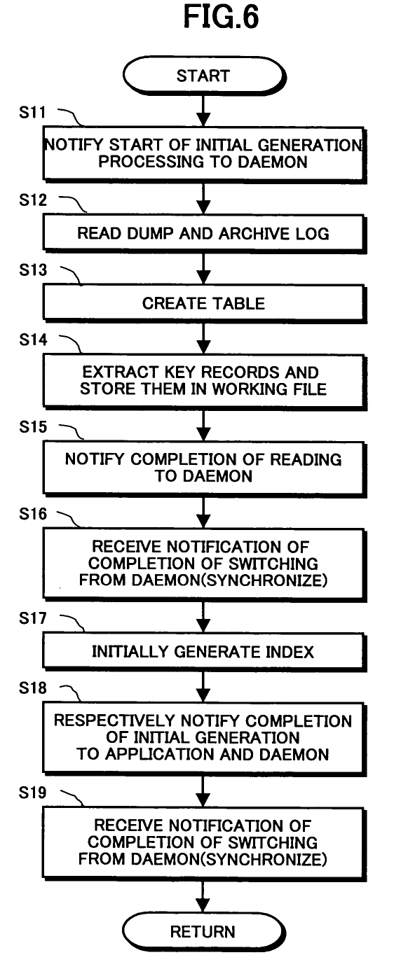

In step 4, a subroutine that performs the initial index generation processing (see FIG. 6) is called.

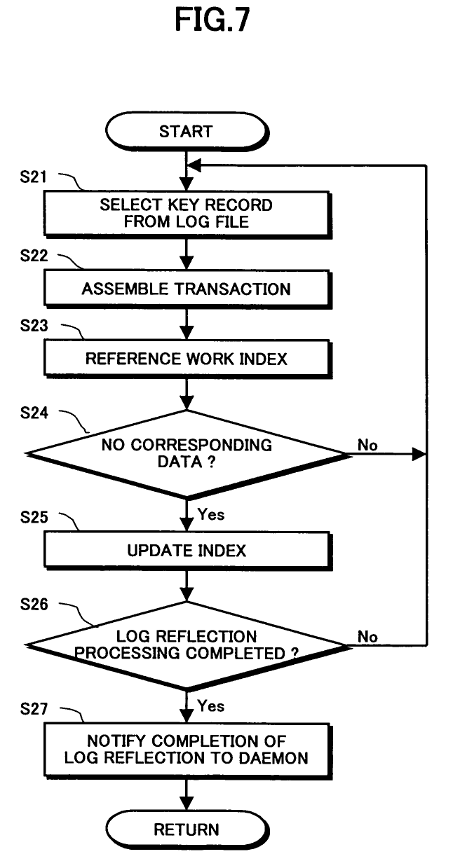

In step 5, a subroutine that performs the log reflection processing (see FIG. 7) is called.

In step 6, completion of the generation processing is notified to the application 10.

In step 7, recognition notification from the application 10 is received in order to synchronize with the application 10.

In step 8, the operating environment is recovered.

Referring to the flow chart of FIG. 6, a description of the subroutine of the initial index generation processing is provided hereinbelow.

In step 11, the start of the initial generation processing is notified to the index generating daemon 30.

In step 12, the dump file 50A and the archive log file 50B are each read.

In step 13, a table 60 in which the content of the DB 40 at the time of the start of the initial index generation processing is reconstructed, is created from the read dump file 50A and archive log file 50B.

In step 14, key records are extracted from the created table 60, and the key records are stored in the working file 70.

In step 15, completion of reading is notified to the index generating daemon 30, in order to switch the processing in the index generating daemon 30.

In step 16, notification of completion of switching from the index generating daemon 30 is received, in order to synchronize with the index generating daemon 30.

In step 17, the index 80 to be newly added is initially generated from the key records stored in a sorted condition in the working file 70. At this time, as there are no effects on the index 80 when insertion and deletion of key records of the same key value and TID are performed, then by disregarding these, efficiency of the initial index generation can be increased. Here the series of processing in steps 12, 13, 14, and 17 correspond to the initial generation device or means.

In step 18, in order to switch processing in the application 10 and the index generating daemon 30, both are respectively notified of the completion of the initial generation processing.

In step 19, notification of completion of switching from the index generating daemon 30 is received, in order to synchronize with the index generating daemon 30.

Referring to the flowchart of FIG. 7, a description of the subroutine of the log reflection processing is provided hereunder.

In step 21, one key record for the oldest point in the time series, is selected from the log file 90.

In step 22, a transaction is assembled in accordance with the key record.

In step 23, the work index 100 is referenced.

In step 24, it is determined whether or not the data corresponding to the selected key record, that is, the key record of the same key value and TID, is stored in the work index 100. Then, if the corresponding data is not stored (Yes), control proceeds to step 25. If the corresponding data is stored (No), control returns to step 21. Here, the work index 100 is used to determine whether or not the key records stored in the log file 90 are allowed to be reflected to index 80.

In step 25, the index 80 is updated in accordance with the selected record.

In step 26, it is determined whether or not the log reflection processing is completed, namely, whether or not processing of all the key records stored in the log file 90 is completed. Then, if the log reflection processing is completed (Yes), control proceeds to step 27, and completion of the log reflection is notified to the index generating daemon 30. On the other hand, if the log reflection processing is not completed (No), control returns to step 21 in order to process the next key record. The series of processing in steps 21 to 26 correspond to the log reflection device or means.

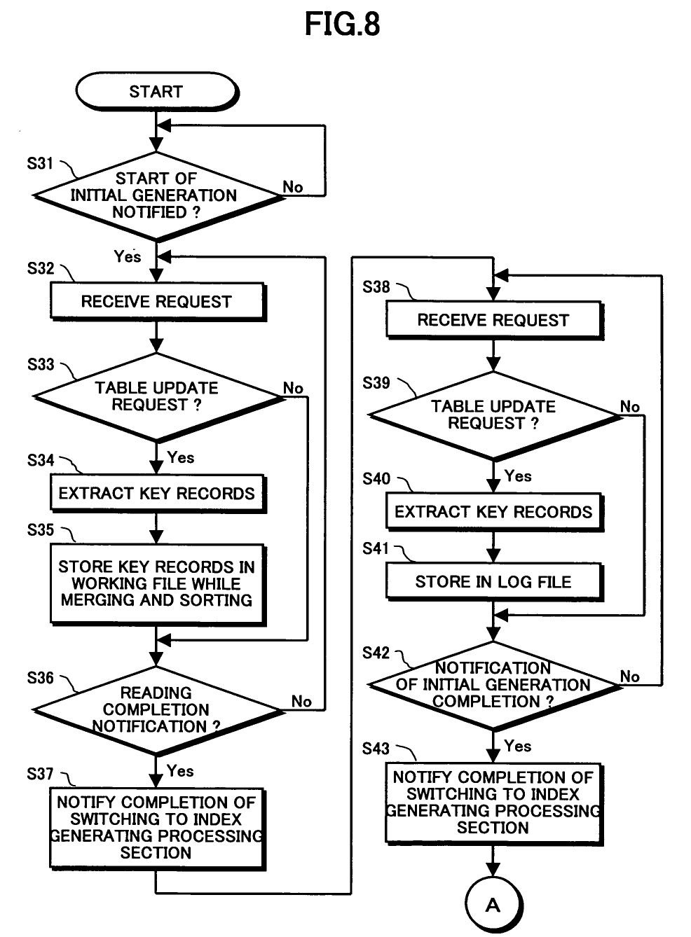

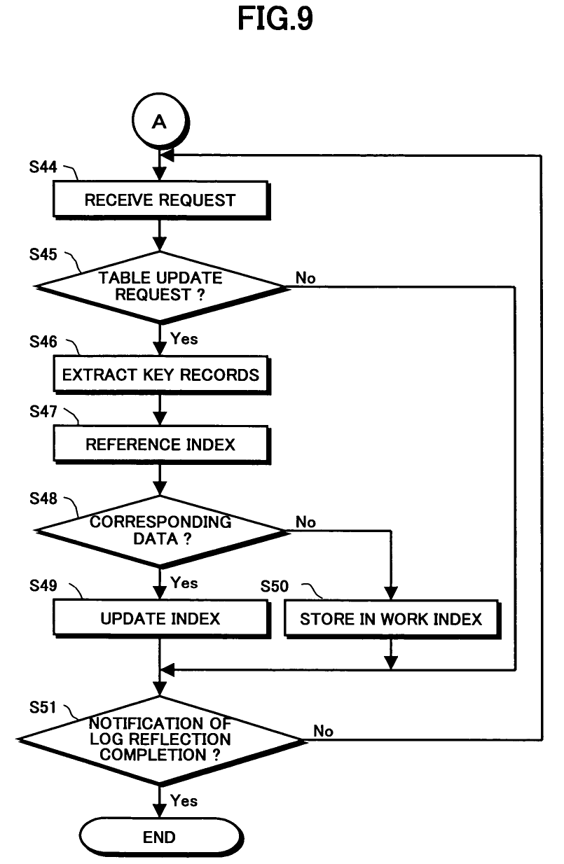

FIGS. 8 and 9 show the processing content that is repeatedly performed in the index generating daemon 30, for each predetermined time.

In step 31, in order to determine whether or not the index generation processing should start, it is determined whether or not the start of initial generation has been notified from the index generation processing section 20. Then, if there has been a notification of starting of the initial generation (Yes), control proceeds to step 32, while if there has not been a notification of starting of the initial generation (No), processing stands by.

In step 32, the request from the application 10 is received.

In step 33, it is determined whether or not the received request is a table update request Then, if it is a table update request (Yes), control proceeds to step 34, whereas if it is not a table update request (No), control proceeds to step 36.

In step 34, the key records related to the table update are extracted from the received request.

In step 35, the key values are selected from the key records stored in the working file 70, while merging the extracted key records with the working file 70, and the key records are sorted so that these are in ascending order.

In step 36, it is determined whether or not there has been a notification of reading completion from the index generation processing section 20. Then, if there has been a notification of reading completion (Yes), control proceeds to step 37, whereas if there has not been a notification of reading completion (No), control returns to step 32.

In step 37, the completion of switching is notified to the index generating processing section 20.

In step 38, the request from the application 10 is received.

In step 39, it is determined whether or not the received request is a table update request Then, if it is a table update request (Yes), control proceeds to step 40, whereas if it is not a table update request (No), control proceeds to step 42.

In step 40, the key records related to the table update are extracted from the received request.

In step 41, the extracted key records are stored in the log file 90. At this time, the key records are stored in the log file 90 in accordance with predetermined rules, so that their occurrence order is guaranteed.

In step 42, it is determined whether or not there has been a notification of initial generation completion, from the index generation processing section 20. Then, if there has been a notification of initial generation completion (Yes), control proceeds to step 43, whereas if there has not been a notification of initial generation completion (No), control returns to step 38. The series of processing in steps 38 to 42 correspond to the log accumulating device or means.

In step 43, the completion of switching is notified to the index generating processing section 20.

In step 44, the request from the application 10 is received.

In step 45, it is determined whether or not the received request is a table update request Then, if it is a table update request (Yes), control proceeds to step 46, whereas if it is not a table update request (No), control proceeds to step 51.

In step 46, the key records related to the table update are extracted from the received request.

In step 47, the index 80 is referenced.

In step 48, it is determined whether or not the data corresponding to the extracted key record, namely, the key record of the same key value is stored in the index 80. Then, if the corresponding data is stored (Yes), control proceeds to step 49, and the index 80 is updated in accordance with the key record. On the other hand, if the corresponding data is not stored (No), control proceeds to step 50, and the key record is stored in the work index 100.

In step 51, it is determined whether or not there has been a notification of log reflection completion from the index generation processing section 20. Then, if there has been a notification of log reflection completion (Yes), the processing is terminated, whereas if there has not been a notification of log reflection completion (No), control returns to step 44. The series of processing in steps 44 to 51 corresponds to the update request processing device or means.

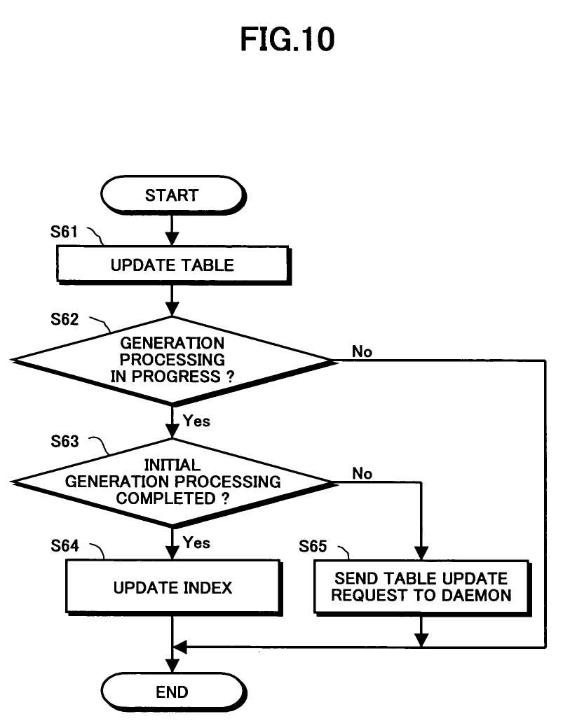

Referring to the flow chart of FIG. 10, the processing content that is executed in the application 10, with the table update as a trigger is shown. In order to synchronize with the index generation processing section 20, the application 10 responds to the notification of generation processing start and the notification of generation processing completion from the index generation processing section 20, and sends respective replies with notification of recognition.

In step 61, the table that configures the DB 40 is updated.

In step 62, it is determined whether or not the index generation processing is in progress, that is, whether or not there has been a notification of generation processing start, and no notification of completion of generation processing. Then, if index generation processing is in progress (Yes), control proceeds to step 63, whereas if index generation processing is not in progress (No), the processing is terminated.

In step 63, it is determined whether or not the initial index generation processing is completed, that is, whether or not there has been a notification of initial index generation completion. Then, if the initial index generation processing is completed (Yes), control proceeds to step 64, and the index 80 is directly updated in accordance with a request related to table update. On the other hand, if the initial index generation processing is not completed (No), control proceeds to step 65, and the request related to table update is sent to the index generating daemon 30.

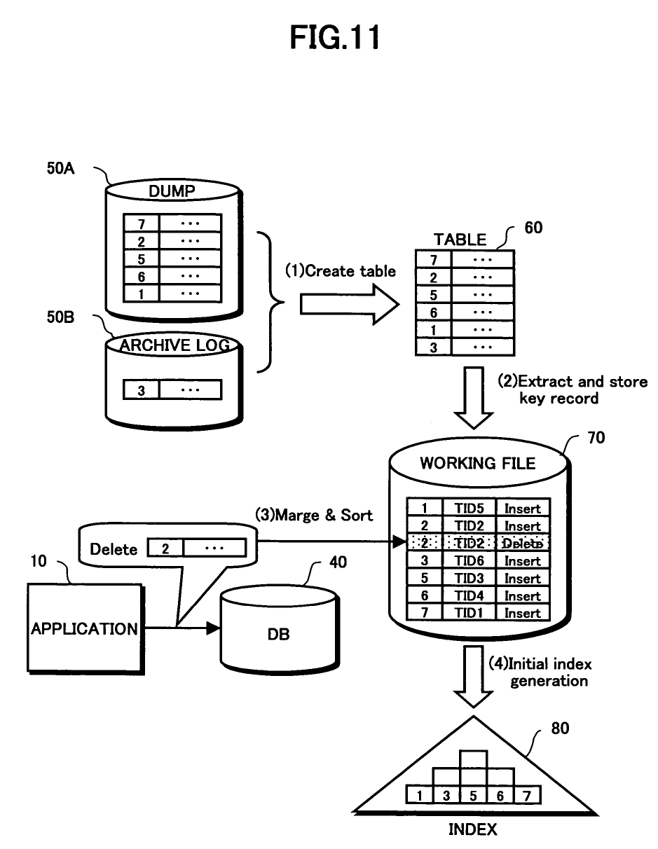

According to the processing described above, in the initial index generation processing, as shown in FIG. 11, the table 60 in which the content of the DB 40 at the time of start of the initial index generation processing is reconstructed, is created from the dump file 50A and the archive log file 50B which serve as back up data. Therefore, since the table that configures the DB 40 does not need to be accessed, and disk I/O competition with the application 10 can be avoided, then even when the index generation processing is in progress, a decrease in the response of the service to the application can be suppressed. Afterwards, the key records are extracted from the table 60, and stored in the working file 70.

Moreover, in the interval from the start of reading the dump file 50A and the archive log file 50B, to the completion of storing key records to the working file 70, the key records related to the table update request from the application 10 are sorted in accordance with the key values while being merged with the working file 70. Therefore, the volume of the log during the initial index generation processing is reduced, so that the log reflection processing time for reflecting this to the index 80, in other words, the index generation time can be reduced.

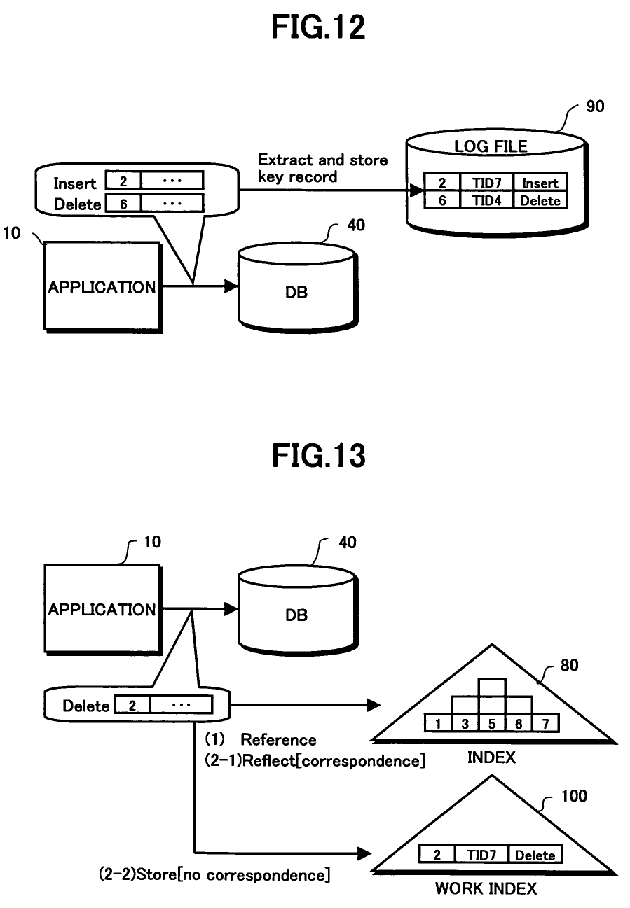

Moreover, when initially generating the index 80 from the key records stored in the working file 70, the key records related to the table update request cannot be merged with the working file 70. Therefore as shown in FIG. 12, the key records are stored in the log file 90, while guaranteeing their occurrence order.

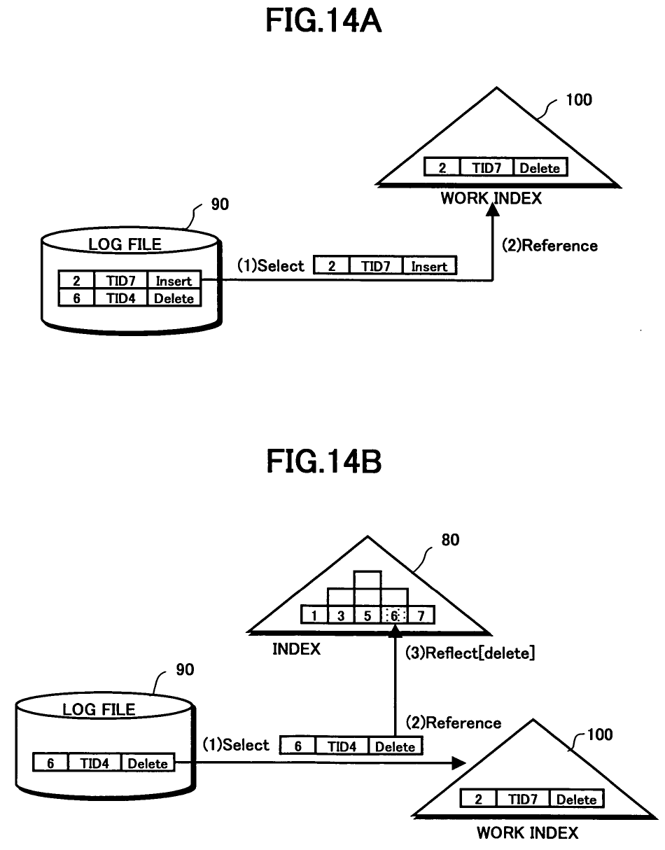

In the log reflection processing, as shown in FIG. 13, the table update request from the application 10 is directly reflected if corresponding data is present in the index 80, whereas if corresponding data is not present in the index 80, the key records are extracted and stored in the work index 100. Furthermore, as shown in FIG. 14A, if the data corresponding to the key records selected from the log file 90 are stored in the index 100, the order of update to the index 80 is determined to be inverted, and as nothing is effected by performing insertion and deletion in this order, the key records are disregarded and nothing is done. On the other hand, as shown in FIG. 14B, if the data corresponding to the selected key records is not stored in the work index 100, the order of update to the index 80 is determined to be guaranteed, and the index 80 is updated in accordance with the key records.

Therefore, when the key records accumulated in the log file 90, that is, the log, is reflected, then by making reference to the working file 100, the order of update to the index 80 is guaranteed. Hence, a new index can be dynamically and efficiently added without stopping the service to the application 10. Moreover, since table update during log reflection processing is directly reflected to the index 80 as long as its update order is guaranteed, log application efficiency can be greatly increased.

I claim:

1. An index adding program of a relational database, for executing on a computer comprising the steps of:
initially generating an index of the relational database;
accumulating an update log for said relational database during said initial index generation;
if after the initial index generation, data corresponding to an update request to said relational database is present in the index, reflecting said update request to the index, or alternatively, if data corresponding to said update request is not present in the index, storing said update request in a first work area; and
when sequentially reflecting an accumulated update log to the initially generated index, disregarding the update log if the data corresponding to said update log is stored in a first work area, or alternatively, reflecting said update log to the index if data corresponding to said update log is not stored in the first work area.

2. An index adding program of a relational database according to claim 1, wherein said step of initially generating an index of said relational database, initially generates an index from back up data appropriately acquired in preparation against destruction of said relational database.

3. An index adding program of a relational database according to claim 2, wherein said back up data is configured from; a dump file in which said relational database has been saved at certain point in time, and an archive log file in which is recorded update contents of said relational database.

4. An index adding program of a relational database according to claim 1, wherein said step of initially generating an index of said relational database comprises the steps of:
extracting key records from said relational database and storing them in a second work area;
merging key records extracted from an update request to said relational database with a corresponding section in said second work area while sorting key records stored in said second work area in accordance with predetermined rules; and
generating an index from the sorted and merged key records.

5. An index adding program of a relational database according to claim 4 comprising a step for, after generation of the index from said sorted and merged key records, until completion of reflection of the accumulated update log to the index, if data corresponding to the update request to said relational database is present in the index, updating said index in accordance with said update request, or alternatively, if data corresponding to said update request is not present in the index, storing the update request in the first work area.

6. An index adding program of a relational database according to claim 4, wherein said step of generating an index from said sorted and merged key records generates an index while disregarding a combination of insertions and deletions to the same index.

7. An index adding apparatus of a relational database comprising:
an initial generation means which initially generates an index of the relational database;
a log accumulating means which accumulates an update log for said relational database during initial index generation by said initial generation device;
an update request processing means which if after the initial index generation by said initial generation device, data corresponding to an update request to said relational database is present in the index, reflects said update request to the index, or alternatively, if data corresponding to said update request is not present in the index, stores said update request in a work area; and
a log reflection means which when sequentially reflecting an accumulated update log to the initially generated index, disregards the update log if the data corresponding to said update log is stored in the work area, or alternatively, reflects said update log to the index if data corresponding to said update log is not stored in the work area.

8. An index adding method of a relational database which executes on a computer comprising the steps of:
initially generating an index of the relational database;
accumulating an update log for said relational database during said initial index generation;
if after the initial index generation, data corresponding to an update request to said relational database is present in the index, reflecting said update request to the index, or alternatively, if data corresponding to said update request is not present in the index, storing said update request in a work area; and
when sequentially reflecting an accumulated update log to the initially generated index, disregarding the update log if the data corresponding to said update log is stored in the work area, or alternatively, reflecting said update log to the index if data corresponding to said update log is not stored in the work area.
